(19) United States
(12) Patent Application Publication
(10) Pub. No.: US 2015/0154466 A1
(43) Pub. Date: Jun. 4, 2015

(54) MOBILE DEVICE AND IMAGE PROCESSING METHOD THEREOF

(71) Applicant: HTC CORPORATION, Taoyuan City (TW)

(72) Inventor: Li-Wei LIN, TAOYUAN CITY (TW)

(73) Assignee: HTC CORPORATION, Taoyuan City (TW)

(21) Appl. No.: 14/093,238

(22) Filed: Nov. 29, 2013

(51) Int. Cl. G06K 9/46; G06K 9/48

(52) U.S. Cl. CPC G06K 9/4671; G06K 9/48

(57) ABSTRACT

A mobile device and an image processing method thereof are provided. The mobile device includes an image capture module and an image processor electrically connected with the image capture module. The image capture module is configured to capture a plurality of images comprising a common object. The image processor is configured to determine the common object as a target object in the plurality of images, compute a saliency map of each of the plurality of images, and determine one major image from the plurality of images according to the target object and the saliency maps. The image processing method is applied to the mobile device to implement the aforesaid operations.

### CROSS-REFERENCES TO RELATED APPLICATIONS

Not applicable.

### BACKGROUND OF THE INVENTION

1. Field of the Invention

The present invention relates to a mobile device and an image processing method thereof. More particularly, the present invention relates to mobile device and an image processing method thereof for image selection.

2. Descriptions of the Related Art

Mobile devices (e.g., cell phones, notebook computers, tablet computers, digital cameras, etc.) are convenient and portable and have become indispensable to people. For example, mobile devices have been extensively used to take pictures and thus, image capture and processes have become popular.

Sometimes, a user takes a plurality of pictures comprising a common object on a conventional mobile device and selects one major image from the plurality of pictures as the best image. However, it is difficult to pick out the major picture from the plurality of pictures because it cannot be automatically and accurately completed on the conventional mobile device. Specifically, the user has to manually pick out the major picture from the plurality of pictures on the conventional mobile device. Therefore, the picture that one user selects as the best image may not be the same that another user selects. Furthermore, manually selecting the picture is time consuming.

In view of this, it is important to provide a method for a conventional mobile device to automatically and accurately select the best image from a plurality of pictures comprising a common object for its user.

### SUMMARY OF THE INVENTION

The objective of the present invention is to provide a method for a conventional mobile device to automatically and accurately select the best image from a plurality of pictures comprising a common object for its user.

To achieve the aforesaid objective, the present invention provides a mobile device. The mobile device comprises an image capture module and an image processor electrically connected with the image capture module. The image capture module is configured to capture a plurality of images comprising a common object. The image processor is configured to determine the common object as a target object in the plurality of images, compute a saliency map of each of the plurality of images, and determine one major image from the plurality of images according to the target object and the saliency maps.

To achieve the aforesaid objective, the present invention provides an image processing method for use in a mobile device. The mobile device comprises an image capture module and an image processor electrically connected with the image capture module. The image processing method comprising the following steps:

(a1) capturing a plurality of images comprising a common object by the image capture module;

(b1) determining the common object as a target object in the plurality of images by the image processor;

(c1) computing a saliency map of each of the plurality of images by the image processor; and

(d1) determining one major image from the plurality of images according to the target object and the saliency maps by the image processor.

In summary, the present invention provides a mobile device and an image processing method thereof. With the aforesaid arrangement of the image capture module, the mobile device and the image processing method can capture a plurality of images comprising a common object. With the aforesaid arrangement of the image processor, the mobile device and the image processing method can determine the common object as a target object in the plurality of images and compute a saliency map of each of the plurality of images.

The saliency map can presents various image parts with different saliency values in each of the plurality of images. One image part with better saliency value is more likely to attract the attention of human observers. According to the saliency maps, the mobile device and the image processing method can determine at least one saliency maps where the target object corresponds to the image part with the best saliency value, thereby, picking out the best image from the plurality of images. Consequently, the present invention can effectively provide a method for a conventional mobile device to automatically and accurately select the best image from a plurality of pictures comprising a common object for its user.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

FIG. 1 is a schematic view of a mobile device according to a first embodiment of the present invention;

FIG. 2 is a schematic view illustrating a plurality of images and their saliency maps according to the first embodiment of the present invention;

FIG. 3 is a flowchart diagram of an image processing method according to a second embodiment of the present invention; and

FIG. 4A and 4B illustrate different sub-steps of step S27 shown in the second embodiment of the present invention.

### DESCRIPTION OF THE PREFERRED EMBODIMENT

The present invention may be explained with reference to the following embodiments. However, these embodiments are not intended to limit the present invention to any specific environments, applications or implementations described in these embodiments. Therefore, the description of these embodiments is only for the purpose of illustration rather than limitation. In the following embodiments and attached drawings, elements not directly related to the present invention are omitted from depiction. In addition, the dimensional relationships among individual elements in the attached drawings are illustrated only for ease of understanding, but not to limit the actual scale.

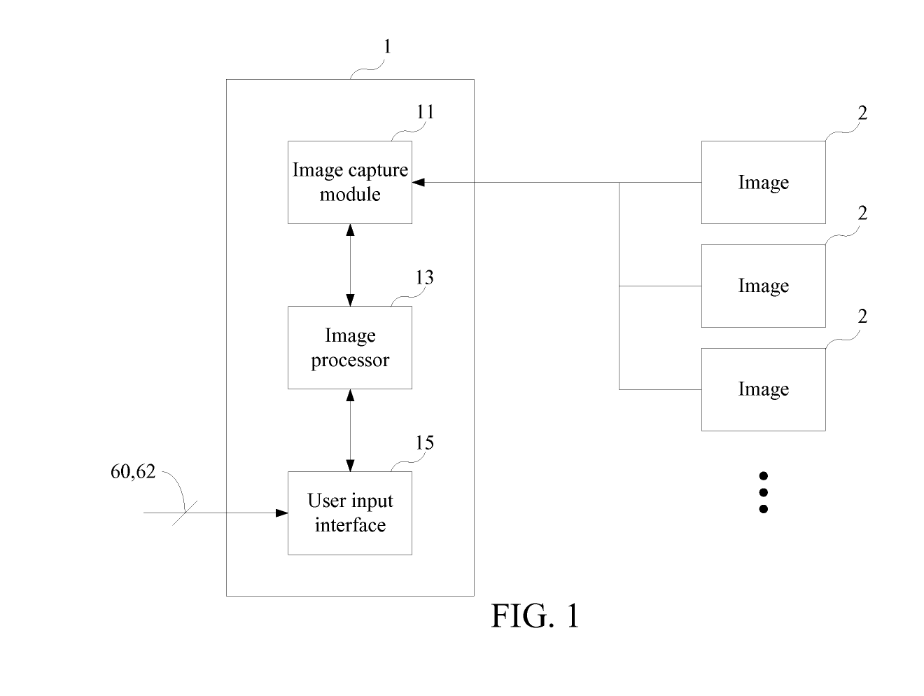

A first embodiment of the present invention is a mobile device. A schematic structural view of the mobile device is shown in FIG. 1 where the mobile device 1 comprises an image capture module 11 and an image processor 13 electrically connected with the connecting module 11. Alternatively, the mobile device 1 may further comprise a user input interface 15 electrically connected with the image processor 13. The mobile device 1 may be a cell phone, a notebook computer, a tablet computer, a digital camera, a PDA, etc.

The image capture module 11 is configured to capture a plurality of images 2 comprising a common object. The image capture module 11 may capture the plurality of images 2 in a continuous burst mode or common mode. In the continuous burst mode, the image capture module 11 continuously captures the plurality of images 2 in a short period. In the common mode, the image capture module 11 individually captures the plurality of images 2 at different moments with a longer time interval.

The image processor 13 is configured to determine the common object as a target object in the plurality of images 2, compute a saliency map of each of the plurality of images 2, and determine one major image from the plurality of images 2 according to the target object and the saliency maps. For ease of the following descriptions, only four images are considered in this embodiment. However, the number of the plurality of images 2 is not a limit to the present invention.

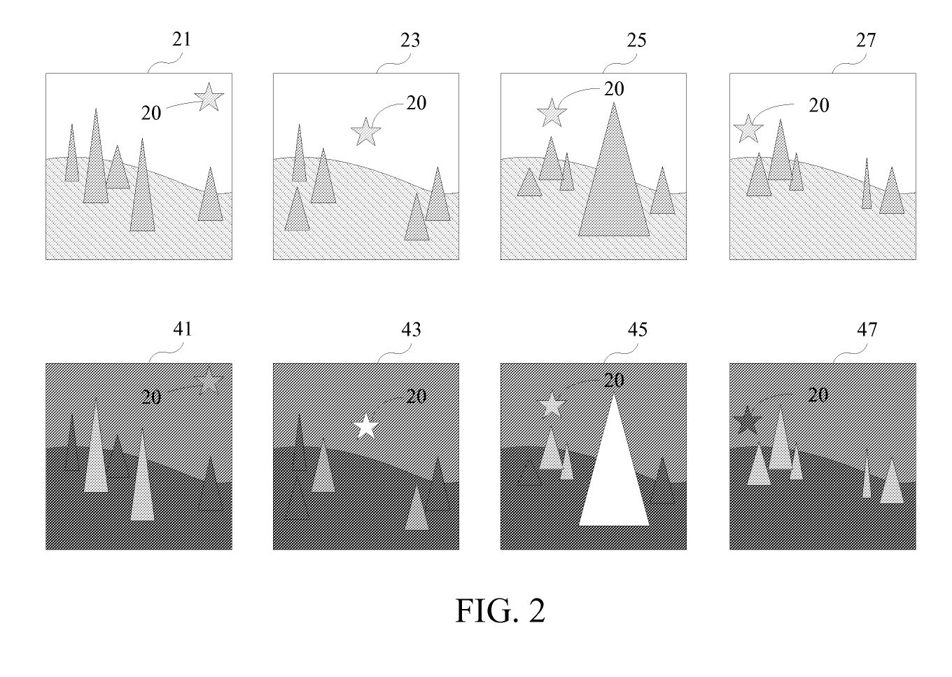

FIG. 2 is a schematic view illustrating a plurality of images and their saliency maps according to the first embodiment of the present invention. As shown in FIG. 2, four images 21, 23, 25 and 27 have been captured by the image capture module 11, and the images 21, 23, 25 and 27 comprising a common object 20 (i.e., the starlike object). Note that the content of each of the images 21, 23, 25 and 27 is only for the purpose of illustration rather than limitation.

Upon capturing the images 21, 23, 25 and 27 by the image capture module 11, the image processor 13 determines the common object 20 as a target object in the images 21, 23, 25 and 27. The target object is what the user wants to emphasize in the images 21, 23, 25 and 27. Specifically, the image processor 13 determines the common object 20 as a target object in the images 21, 23, 25 and 27 according to different conditions.

For example, the user input interface 15 may receive a first user input 60 from the user, and the image processor 13 designates the common object 20 for the images 21, 23, 25 and 27 according to the first user input 60 before the image capture module 11 starts to capture the images 21, 23, 25 and 27. In other words, the common object 20 which is designated by the user is what the user wants to track and emphasize in the images 21, 23, 25 and 27 which will be captured. Consequently, the image processor 13 determines the common object 20 which is designated by the user as the target object in the images 21, 23, 25 and 27.

The method in which the image processor 13 and the image capture module 11 track the common object 20 in the images 21, 23, 25 and 27 can refer to any of conventional object tracking methods such as D. Comaniciu, V. Ramesh, P. Meer, “Kernel-based object tracking,” IEEE Transactions on Pattern Analysis and Machine Intelligence, 25 (5) (2003), pp. 564-575. Because persons skilled in the art can readily appreciate the method of tracing the common object 20 with reference to conventional object tracking methods, it will not be further described herein.

Alternatively, the user input interface 15 does not receive the first user input 60 from the user before the image capture module 11 captures the images 21, 23, 25 and 27. Instead, the user input interface 15 receive a second user input 62 from the user after the image capture module 11 has captured the images 21, 23, 25 and 27. Therefore, the common object 20 which is designated by the user is what interests the user in the captured images 21, 23, 25 and 27. Consequently, the image processor 13 determines the common object 20 which is designated by the user as the target object in the images 21, 23, 25 and 27 according to the second user input 62.

Using the mobile device 1 without the user input interface 15 as another example, the image processor 13 detects the common object 20 and determines it as the target object in the images 21, 23, 25 and 27 which have been captured by the image capture module 11 according to the an object detection algorithm. The object detection algorithm can refer to any of conventional object detection methods such as W. Hu et al., “A Survey on Visual Surveillance of Object Motion and Behaviors,” IEEE Trans. Systems, Man, and Cybernetics, Part C: Applications and Reviews, vol. 34, no. 3, 2004, pp. 334-352. Because persons skilled in the art can readily appreciate the method of detecting the common object 20 with reference to conventional object detection methods, it will not be further described herein.

Upon capturing the images 21, 23, 25 and 27 by the image capture module 11, the image processor 13 further computes a saliency map of each of the images 21, 23, 25 and 27. As shown in FIG. 2, the saliency maps 41, 43, 45 and 47, which are computed by the image processor 13, correspond to the images 21, 23, 25 and 27 respectively. The method in which the image processor 13 computes the saliency maps 41, 43, 45 and 47 can refer to any of conventional saliency map calculation methods such as L. Itti and C. Koch, “Computational modeling of visual attention,” Nature reviews neuroscience, vol. 2, pp. 194-203, 2001. Because persons skilled in the art can readily appreciate the method of computing the saliency maps 41, 43, 45 and 47 with reference to conventional saliency map calculation methods, it will not be further described herein.

The saliency maps 41, 43, 45 and 47 are respectively used to present various image parts with different saliency values in the images 21, 23, 25 and 27, and one image part with greater saliency value is more likely to attract the attention of human observers. Specifically, upon computing the saliency maps 41, 43, 45 and 47, the image processor 13 further computes a saliency value of the target object in each of the saliency maps 41, 43, 45 and 47. Next, the image processor 13 determines one saliency map candidate from the saliency maps 41, 43, 45 and 47. The saliency value of the target object is greater than a pre-defined saliency threshold. The major image (i.e., the best image) is then determined according to the saliency map candidate. Note that the pre-defined saliency thresholds of the saliency map 41, 43, 45 and 47 can be determined according to different applications, which can be identical or different.

The saliency value of the target object and the pre-defined saliency threshold may be quantized in gray scale. The gray scale includes 256 intensities which vary from black at the weakest intensity to white at the strongest. The binary representations assume that the minimum value (i.e., 0) is black and the maximum value (i.e., 255) is white. Therefore, in each of the saliency maps 41, 43, 45 and 47, the target object with a higher saliency value shows brighter, while that with a lower one shows darker.

With reference to FIG. 2, the target object (i.e., the common object 20) in the saliency map 41 is too far from the center and will be missed. Therefore, the target object is a relatively darker object as presented in the saliency map 41. In other words, the saliency value of the target object in the saliency map 41 is lower than the pre-defined saliency threshold. For example, the pre-defined saliency threshold of the saliency map 41 is determined as the gray value of 220, but the saliency value of the target object in the saliency map 41 merely corresponds to the gray value of 150.

Likewise, the target object in the saliency map 47 is too far from the center. In addition, there are some other objects that appear around the target object which can be hidden from the viewer's sight. Therefore, the target object is a very dark object as presented in the saliency map 47. In other words, the saliency value of the target object in the saliency map 47 is substantially lower than the pre-defined saliency threshold. For example, the pre-defined saliency threshold of the saliency map 47 is determined as the gray value of 220, but the saliency value of the target object in the saliency map 47 merely corresponds to the gray value of 90.

Unlike the target object presented in the saliency maps 41 and 47, the target object in the saliency map 45 appears near the center. However, a bigger and more attractive object appears near the target object so that the target object in the saliency map 45 is a relatively brighter object but not the brightest one. In other words, the saliency value of the target object in the saliency map 45 is lower than, but close to, the pre-defined saliency threshold.

For example, the pre-defined saliency threshold of the saliency map 45 is determined as the gray value of 220, while the saliency value of the target object in the saliency map 45 corresponds to the gray value of 205.

Among the saliency maps 41, 43, 45 and 47, the target object in the saliency maps 43 is most attractive because it appears not only near the center but also without any obstacles around it. Therefore, the target object is the brightest object as presented in the saliency map 43. In other words, the saliency value of the target object in the saliency map 43 is greater than the pre-defined saliency threshold. For example, the pre-defined saliency threshold of the saliency map 43 is determined as the gray value of 220, while the saliency value of the target object in the saliency map 43 corresponds to the gray value of 230.

According to the saliency maps 41, 43, 45 and 47, the image processor 13 determines the saliency map 43 as the saliency map candidate from the saliency maps 41, 43, 45 and 47, and finally determines the image 23 as the major image according to the saliency map 43. In another embodiment, the image processor 13 may determine the major image by further applying a filter to each of the saliency maps 41, 43, 45 and 47. In such a way, the character of the target object in each of saliency maps 41, 43, 45 and 47 can be intensified effectively.

The aforesaid filter can refer to any of conventional filtering methods such as L. Itti and C. Koch, “A saliency-based search mechanism for overt and covert shifts of visual attention,” Vision Research, vol. 40, pp. 1489-1506, 2000. Because persons skilled in the art can readily appreciate the method of filtering the saliency maps 41, 43, 45 and 47 with reference to conventional filtering methods, it will not be further described herein.

On the other hand, it is possible that the saliency values of the target object in two or more of the saliency maps 41, 43, 45 and 47 are greater than their pre-defined saliency threshold so that the image processor 13 determines two or more saliency map candidates from the saliency maps 41, 43, 45 and 47. In this case, the image processor 13 further makes a comparison of the saliency map candidates, and then determines the major image according to the comparison result of the saliency map candidates.

For example, the image processor 13 may compare the saliency values of the target object among the saliency map candidates to find out the best saliency map candidate in which the saliency value of the target object is the largest. Next, the image processor 13 determines the major image according to the best saliency map candidate. Except for the comparison of the saliency values, the image processor 13 may also compare the saliency map candidates with other items to find out the best saliency map candidate.

A second embodiment of the present invention is an image processing method. The image processing method described in this embodiment may be applied to the mobile device 1 described in the first embodiment. Therefore, the mobile device described in this embodiment may be considered as the mobile device 1 described in the first embodiment.

The mobile device described in this embodiment may comprise an image capture module and an image processor electrically connected with the image capture module.

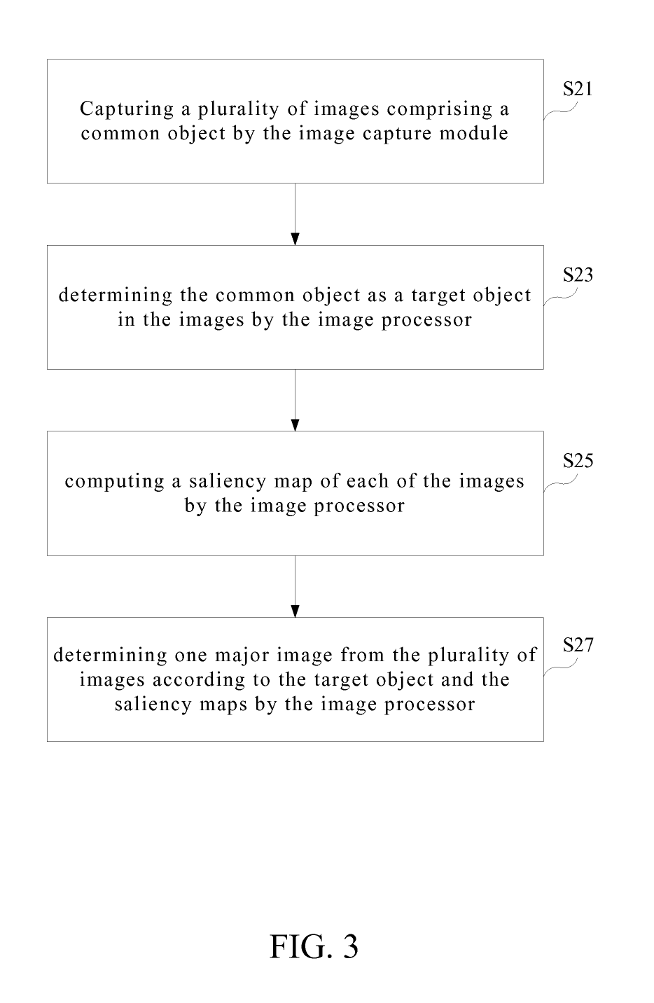

A flowchart diagram of the image processing method is shown in FIG. 3. As shown in FIG. 3, step S21 is executed to capture a plurality of images comprising a common object by the image capture module; step S23 is executed to determine the common object as a target object in the images by the image processor; step S25 is executed to compute a saliency map of each of the images by the image processor; and step S27 is executed to determine one major image from the plurality of images according to the target object and the saliency maps by the image processor.

In an example of this embodiment, step S21 may further be a step of capturing the plurality of images comprising the common object in continuous burst mode by the image capture module.

In an example of this embodiment, the mobile device may further comprise a user input interface electrically connected with the image processor for receiving a first user input. In addition, before step S21 is executed, the image processing method may further comprise a step of designating the common object for the plurality of images according to the first user input by the image processor.

In an example of this embodiment, the mobile device may further comprise a user input interface electrically connected with the image processor for receiving a second user input. In addition, step S23 is a step of determining the common object as the target object in the plurality of images according to the second user input by the image processor.

In an example of this embodiment, step S23 may further be a step of determining the common object as the target object in the plurality of images according to an object detection algorithm by the image processor.

In an example of this embodiment, step S27 may further comprise a step of applying a filter to each of the saliency maps by the image processor.

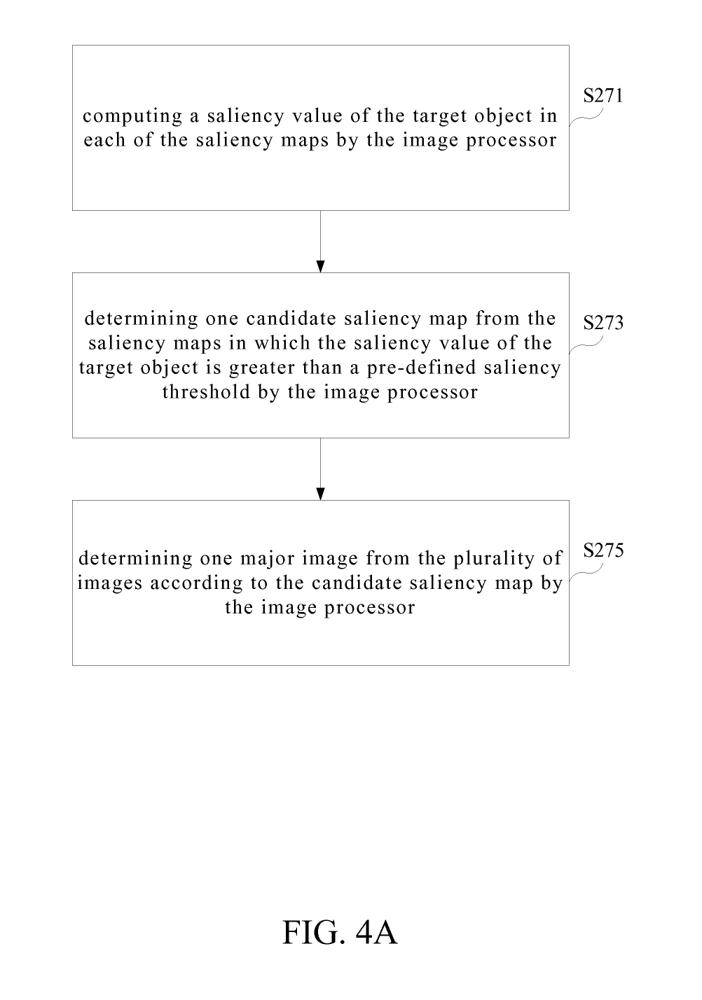

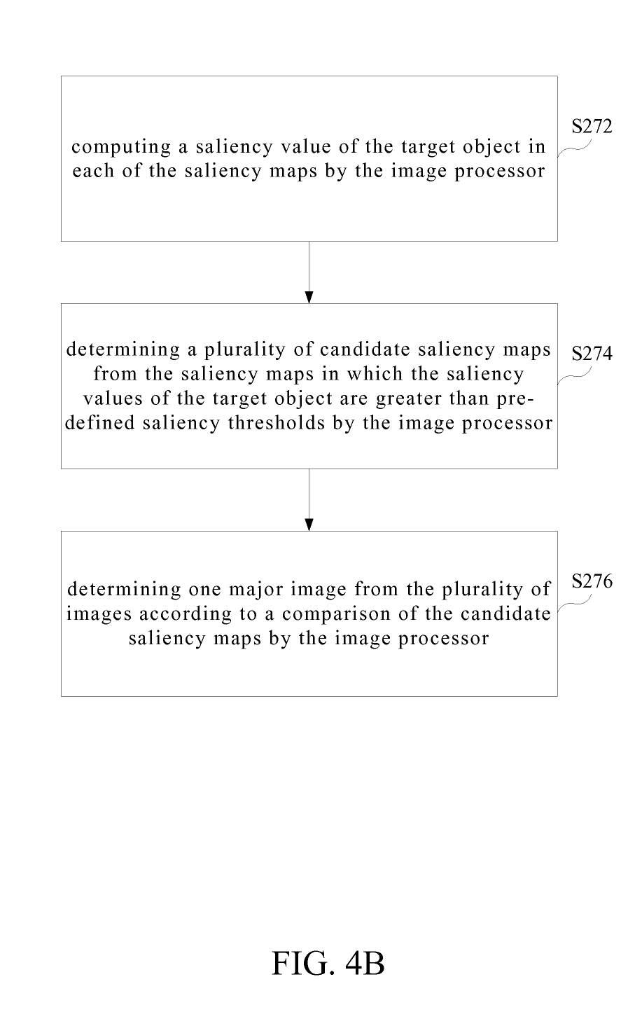

In an example of this embodiment, as shown in FIG. 4A, step S27 may comprise steps S271, S273 and S275. Step S271 is executed to compute a saliency value of the target object in each of the saliency maps by the image processor; step S273 is executed to determine one candidate saliency map from the saliency maps in which the saliency value of the target object is greater than a pre-defined saliency threshold by the image processor; and step S275 is executed to determine one major image from the plurality of images according to the candidate saliency map by the image processor.

In an example of this embodiment, as shown in FIG. 4B, step S27 may comprise steps S272, S274 and S276. Step S272 is executed to compute a saliency value of the target object in each of the saliency maps by the image processor; step S274 is executed to determine a plurality of candidate saliency maps from the saliency maps in which the saliency values of the target object are greater than pre-defined saliency thresholds by the image processor; and step S276 is executed to determine one major image from the plurality of images according to a comparison of the candidate saliency maps by the image processor.

In addition to the aforesaid steps, the image processing method of this embodiment further comprises other steps corresponding to all the operations of the mobile device 1 set forth in the first embodiment and accomplishes all the corresponding functions. Since the steps which are not described in this embodiment can be readily appreciated by persons of ordinary skill in the art based on the explanations of the first embodiment, they will not be further described herein.

According to the above descriptions, the present invention provides a mobile device and an image processing method thereof. With the aforesaid arrangement of the image capture module, the mobile device and the image processing method can capture a plurality of images comprising a common object. With the aforesaid arrangement of the image processor, the mobile device and the image processing method can determine the common object as a target object in the plurality of images and compute a saliency map of each of the plurality of images.

The saliency map can present various image parts with different saliency values in each of the plurality of images. One image part with better saliency value is more likely to attract the attention of viewers. According to the saliency maps, the mobile device and the image processing method can determine at least one saliency maps where the target object corresponds to the image part with the best saliency value, thereby, picking out the best image from the plurality of images. Consequently, the present invention effectively provides a method for a conventional mobile device to automatically and accurately select the best image from a plurality of pictures comprising a common object for its user.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile device, comprising:
an image capture module, configured to capture a plurality of images comprising a common object; and
an image processor, electrically connected with the image capture module and configured to determine the common object as a target object in the plurality of images, compute a saliency map of each of the plurality of images, and determine one major image from the plurality of images according to the target object and the saliency maps.

2. The mobile device as claimed in claim 1, further comprising a user input interface for receiving a first user input, wherein the image processor further designates the common object for the plurality of images according to the first user input.

3. The mobile device as claimed in claim 1, further comprising a user input interface for receiving a second user input, wherein the image processor determines the common object as the target object in the plurality of images according to the second user input.

4. The mobile device as claimed in claim 1, wherein the image processor determines the common object as the target object in the plurality of images according to an object detection algorithm.

5. The mobile device as claimed in claim 1, wherein the image processor further computes a saliency value of the target object in each of the saliency maps, determine one saliency map candidate from the saliency maps in which the saliency value of the target object is greater than a pre-defined saliency threshold, and determine the major image according to the saliency map candidate.

6. The mobile device as claimed in claim 1, wherein the image processor further computes a saliency value of the target object in each of the saliency maps, determine a plurality of saliency map candidates from the saliency maps in which the saliency values of the target object are greater than pre-defined saliency thresholds, and determine the major image according to a comparison of the saliency map candidates.

7. The mobile device as claimed in claim 1, wherein the image processor further determines the major image by applying a filter to each of the saliency maps.

8. The mobile device as claimed in claim 1, wherein the image capture module is further configured to capture the plurality of images in a continuous burst mode.

9. An image processing method for use in a mobile device, the mobile device comprising an image capture module and an image processor electrically connected with the image capture module, the image processing method comprising the following steps:
(a1) capturing a plurality of images comprising a common object by the image capture module;
(b1) determining the common object as a target object in the plurality of images by the image processor;
(c1) computing a saliency map of each of the plurality of images by the image processor; and
(d1) determining one major image from the plurality of images according to the target object and the saliency maps by the image processor.

10. The image processing method as claimed in claim 9, wherein the mobile device further comprises a user input interface for receiving a first user input, and the image processing method further comprises the following step:
(a0) designating the common object for the plurality of images according to the first user input by the image processor.

11. The image processing method as claimed in claim 9, wherein the mobile device further comprises a user input interface for receiving a second user input, and step (b1) is a step of determining the common object as the target object in the plurality of images according to the second user input by the image processor.

12. The image processing method as claimed in claim 9, wherein step (b1) is a step of determining the common object as the target object in the plurality of images according to an object detection algorithm by the image processor.

13. The image processing method as claimed in claim 9, wherein step (d1) comprises the following steps:
(d11) computing a saliency value of the target object in each of the saliency maps by the image processor;
(d12) determining one saliency map candidate from the saliency maps in which the saliency value of the target object is greater than a pre-defined saliency threshold by the image processor; and
(d13) determining the major image from the plurality of images according to the saliency map candidate by the image processor.

14. The image processing method as claimed in claim 9, wherein step (d1) comprises the following steps:
(d11) computing a saliency value of the target object in each of the saliency maps by the image processor;
(d12) determining a plurality of saliency map candidates from the saliency maps in which the saliency values of the target object are greater than pre-defined saliency thresholds by the image processor; and
(d13) determining the major image from the plurality of images according to a comparison of the saliency map candidates by the image processor.

15. The image processing method as claimed in claim 9, wherein step (d1) further comprises the following step:
(d2) applying a filter to each of the saliency maps by the image processor.

16. The image processing method as claimed in claim 9, wherein step (a1) is a step of capturing the plurality of images comprising the common object in a continuous burst mode by the image capture module.
